(19) United States
(12) Patent Application Publication
(10) Pub. No.: US 2022/0236605 A1
(43) Pub. Date: Jul. 28, 2022

(54) DISPLAY COVER, MANUFACTURING METHOD THEREOF, AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Yunti Zhang, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/251,777

(22) PCT Filed: Aug. 19, 2020
(86) PCT No.: PCT/CN2020/110020

§ 371 Date: Dec. 11, 2020

(30) Foreign Application Priority Data
Aug. 11, 2020 (CN) 202010801609.4

(51) Int. Cl. G02F 1/1333; G02F 1/1335

(52) U.S. Cl. CPC G02F 1/133331; G02F 2202/28; G02F 1/133512

(57) ABSTRACT

The present application provides a display cover, a manufacturing method of the display cover, and a display device. The display cover includes: a substrate; a light shielding layer; and an optical adhesive layer. The substrate includes a visible region and a non-visible region, and the non-visible region is provided with at least one notch. The light shielding layer is disposed in the notch in the non-visible region. The optical adhesive layer covers the light shielding layer and the visible region of the substrate. By arranging the light shielding layer in the notch, the present application eliminates an ink level difference caused by coating the light shielding layer in conventional techniques, so that the optical adhesive layer is completely attached to the substrate to avoid generating air bubbles and improve production yields of the display cover.

### FIELD OF DISCLOSURE

The present application relates to a field of display technology and in particular, to a display cover, a manufacturing method thereof, and a display device.

### DESCRIPTION OF RELATED ART

Smartphones have been developed to offer various designs such as ultra-thin bezels, waterfall screens, under-screen cameras, and foldable smartphones. Among them, foldable smartphones are very promising products in the market because they combine the characteristics of tablets and mobile phones.

One of the key technologies for foldable mobile phones is a flexible cover (a cover window) at an outermost layer of a display panel for protecting the same, which requires good flexibility, bendability, wear resistance, and hardness. Except a display area (an active area), the display panel also has non-display areas such as areas where metal traces are arranged, that is, non-visible areas. Within a visible area (a viewable area), the flexible cover is required to have high transmittance. Outside the visible region, the flexible cover has an ink coating design to provide light-shielding functions. Currently, an ink coating is mainly applied by silk screen printing, pad printing, and exposure development. The flexible cover is coated with ink on one side close to the display panel, and then a layer of the optical adhesive is applied onto the ink.

However, the ink is applied after the flexible cover is manufactured, and the ink has a certain thickness, so there is an ink step, that is, an ink level difference. The presence of the ink level difference may cause air bubbles when an optical adhesive is applied to the flexible cover, which affects the product appearance and lower production yields.

Therefore, there is an urgent need to solve the problem of the conventional techniques.

### SUMMARY

It is an objective of the present application to provide a display cover, a manufacturing method thereof, and a display device, so as to solve a conventional problem that the presence of an ink level difference may cause air bubbles when an optical adhesive is attached to a flexible cover. Accordingly, the present application improves production yields of the display cover and improves the display effects of the display device.

In order to solve the above-mentioned problem, the present application provides a display cover, comprising:

a substrate comprising a visible region and a non-visible region, wherein the non-visible region is provided with at least one notch;

a light shielding layer disposed in the notch of the non-visible region; and

an optical adhesive layer covering the light shielding layer and the visible region of the substrate;

wherein a thickness of the light shielding layer is equal to a depth of the notch, and the thickness of the light shielding layer is less than a thickness of the optical adhesive layer.

In some embodiments, the substrate further comprises a hardening layer disposed at one side of the substrate away from the light shielding layer and covering the substrate.

In some embodiments, a material of the light shielding layer is light-shielding ink.

In some embodiments, a refractive index of the substrate is less than a refractive index of the optical adhesive layer.

In some embodiments, a material of the light shielding layer is light-shielding ink.

In some embodiments, the light shielding ink is black light-shielding ink.

In some embodiments, a longitudinal cross section of the notch comprises a shape of one of a triangle, a semicircle, a rectangle, and a trapezoid.

The present application provides a display cover, comprising:

a substrate comprising a visible region and a non-visible region, wherein the non-visible region is provided with at least one notch;

a light shielding layer disposed in the notch of the non-visible region; and

an optical adhesive layer covering the light shielding layer and the visible region of the substrate.

In some embodiments, the substrate further comprises a hardening layer disposed at one side of the substrate away from the light shielding layer and covering the substrate.

In some embodiments, a thickness of the light shielding layer is equal to a depth of the notch.

In some embodiments, a thickness of the light shielding layer is less than a thickness of the optical adhesive layer.

In some embodiments, a refractive index of the substrate is less than a refractive index of the optical adhesive layer.

In some embodiments, a material of the light shielding layer is light-shielding ink.

In some embodiments, the light shielding ink is black light-shielding ink.

In some embodiments, a longitudinal section of the notch has a shape of one of a triangle, a semicircle, a rectangle, and a trapezoid.

In some embodiments, a material of the optical adhesive layer is at least one of an acrylic adhesive, organic silica gel, rubber, epoxy resin, and a semi-cured liquid optical adhesive.

The present application further provides a manufacturing method of the display cover, comprising following steps:

providing a substrate, wherein at least one notch is formed in one side of the substrate;

filling a light shielding material in the notch to form a light shielding layer; and

forming an optical adhesive layer by attaching an optical adhesive layer to one side of the substrate where the light shielding layer is formed.

In some embodiments, the manufacturing method of the display cover further comprises following steps: hardening an entire surface of the substrate on one side facing away from the at least one notch to form a hardening layer.

The present application further provides a display device, comprising the display cover and the display panel mentioned above, wherein the display cover is arranged on a light-emitting side of the display panel.

In some embodiments, the display device further comprises a polarizer arranged between the display panel and the display cover.

The present application provides a display cover, a manufacturing method thereof, and a display device. The display cover comprises: a substrate, wherein the substrate comprises a visible region and a non-visible region, and the non-visible region is provided with at least one notch; a light shielding layer, wherein the light shielding layer is disposed in the notch of the non-visible region; an optical adhesive layer covering the light shielding layer and the visible region of the substrate. By arranging the light shielding layer in the notch, the present application can eliminate an ink level difference caused by coating the light shielding layer in the conventional techniques, so that the optical adhesive layer is completely attached to the substrate, and thereby the present application can avoid generating air bubbles and improve production yields of the display cover, and in addition to that, since there is no ink level difference, the thickness of the optical adhesive layer can be reduced, a thickness of the display device can also be reduced, and the product can be more aesthetic.

In addition, the entire surface of the substrate away from the notch is hardened to form the hardening layer. The hardening layer can ensure that the display cover has good flexibility and bendability, and at the same time has good wear resistance and hardness, thereby improving the product quality.

### BRIEF DESCRIPTION OF DRAWINGS

The following describes specific embodiments of the present application in detail with reference to the accompanying drawings, which will make the technical solutions and advantages of the present application clear.

FIG. 1 is a schematic structural view illustrating a display cover according to one embodiment of the present application.

FIG. 2 is a process flow diagram illustrating a manufacturing method of the display cover according to one embodiment of the present application.

FIGS. 3A to 3D are schematic structural views illustrating each part of the display cover according to one embodiment of the present application.

FIG. 4 is a schematic structural view illustrating a display device according to one embodiment of the present application.

### DETAILED DESCRIPTION OF EMBODIMENTS

The technical solutions of the present application will be clearly and completely described below in conjunction with the accompanying drawings with reference to specific embodiments of the present application. Obviously, the described embodiments are only some embodiments of the present application, rather than all the embodiments. Based on the embodiments of the present application, all other embodiments obtained by those skilled in the art without creative work are within the protection scope of the present application.

In the description of the present application, it should be understood that the directional terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” are based on the orientation or positional relationship shown in the drawings. The directional terms are only for the convenience of describing the preset application and simplifying the description, and do not indicate or imply that the device or element referred to must have a specific orientation, or be constructed and operated in a specific orientation. Therefore, the directional terms cannot be understood as restrictions on the present application. In addition, the terms “first” and “second” are only used for illustrative purposes, and cannot be understood as indicating or implying relative importance or implicitly indicating the number of indicated technical features. Therefore, the features defined with “first” and “second” may explicitly or implicitly include one or more of the features. In the description of the present application, “multiple” means two or more than two, unless otherwise specifically defined.

In the description of this application, it should be noted that, unless otherwise clearly specified and defined, the terms “mounted”, “connected” and “coupled” should be understood in a broad sense. For example, it can be a fixed connection or a detachable connection. Two elements can be integrally connected, or mechanically connected, or electrically connected, or can interconnect with each other. Two elements can be directly connected, or indirectly connected through an intermediary. Two elements can communicate or interact with each other. For those of ordinary skill in the art, the specific meanings of the above terms in the present application can be understood on a case-by-case basis.

In the present application, unless otherwise expressly defined, a first element being “on” or “under” a second element can mean that, the first and second elements are in direct contact with each other, or the first and second elements make contact through another element between them. Moreover, the first element being “above”, “over”, and “on” the second element can mean that, the first element is right above or obliquely over the second element, or it simply means that the first element is at a higher level than the second element. The first element being “below”, “under”, and “beneath” the second element can mean that the first element being right under or obliquely below the second element, or it simply means that the first element is at a lower level than the second element.

The following description provides various embodiments or examples for realizing different structures of the present application. To simplify the description of the present application, components and configurations of some specific examples are described below. Certainly, they are only examples and are not intended to limit the present application. In addition, the present application may repeat reference numerals and/or reference letters in different examples. Such repetition is for the purpose of simplification and clarity, and does not indicate the relationship between the various embodiments and/or configurations discussed. In addition, although the present application provides examples regarding various specific processes and materials, those of ordinary skill in the art may can use other processes and/or other materials instead.

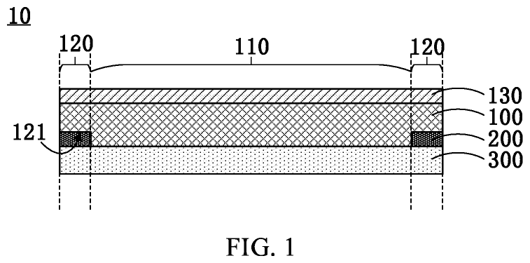

Please refer to FIG. 1. FIG. 1 is a schematic structural view illustrating a display cover 10 according to one embodiment of the present application. The display cover 10 comprises:

a substrate 100 comprising a visible region 110 and a non-visible region 120, wherein the non-visible region 120 is provided with at least one notch 121;

a light shielding layer 200 disposed in the notch 121 of the non-visible region 120; and

an optical adhesive layer 300 covering the light shielding layer 200 and the visible region 110 of the substrate 100.

The substrate 100 further comprises a hardening layer 130 disposed at one side of the substrate 100 away from the light shielding layer 200 and covering the substrate 100.

In the present application, the substrate 100 is a common substrate in this field, and the substrate 100 can be a glass substrate, a polyimide substrate, or a film substrate. A longitudinal cross-section shape of the notch 121 is one of a triangle, a semicircle, a rectangle, a trapezoid, or other regular shapes. Those skilled in the art can understand that the longitudinal cross-section shape of the notch 121 is not limited to a rectangular shape shown in FIG. 1. The material of the light shielding layer 200 is light-shielding ink, and preferably, the light-shielding ink is black light-shielding ink. A material of the light-shielding ink is a conventional material in this field, so a detailed description thereof is omitted herein for brevity. The optical adhesive layer 300 is made of at least one of an acrylic adhesive material, organic silica gel, rubber, epoxy resin, and a semi-cured liquid optical adhesive.

In the present application, the optical adhesive layer 300 is coated on the substrate 100, and a refractive index of the optical adhesive layer 300 is not less than a refractive index of the substrate 100, so the present application can avoid refraction at an interface between the optical adhesive layer 300 and the substrate 100, which may cause optical problems such as higher reflectivity and lower transmittance of the display cover 10. Accordingly, the present application can improve optical display performance of the display cover 10.

Further, in the above-mentioned display cover of the present application, in order to prevent refraction at a contact interface between the optical adhesive layer 300 and the substrate 100. In practice, the refractive index of the substrate 100 is not greater than a refractive index of a contact surface of the display cover 10, where the substrate 100 is in contact with the optical adhesive layer 300. Specifically, according to the type of the display cover 10, the contact surface where the substrate 100 is in contact with the optical adhesive layer 300 can be different.

In the present application, a depth of the notch 121 (the depth of the notch 121 is a vertical height of a step formed by the notch 121 in the substrate 100) is less than a thickness of the substrate 100 (the thickness of the substrate 100 is a vertical distance between one side of the substrate 100 close to the optical adhesive layer 300 and one side of the substrate 100 away from the optical adhesive layer 300). Those skilled in the art can understand that the notch 121 cannot completely penetrate the substrate 100, and the thickness of the substrate 100 is 4 to 5 times that of the notch 121. Preferably, the thickness of the substrate 100 ranges from 60 um to 100 um, and the depth of the notch 121 ranges from 15 um to 25 um. For example, the thickness of the substrate 100 is 80 um, and the depth of the notch 121 is 20 um; however, the present application is not limited in this regard.

In the present application, a thickness of the light shielding layer 200 (the thickness of the light shielding layer 200 is a vertical distance between one side of the light shielding layer 200 close to the substrate 100 and one side of the light shielding layer 200 away from the substrate 100) is the same as the depth of the notch 121. Those skilled in the art can understand that a surface of the light shielding layer 200 is level with a surface of the substrate 100, and the surface of the light shielding layer 200 and the surface of the substrate 100 are both in contact with the optical adhesive layer 300. By making the surface of the light shielding layer 200 level with the surface of the substrate 100, the present application solves a problem that an ink level difference is caused in conventional techniques after coating the light shielding layer 200, so that the optical adhesive layer 300 and the substrate 100 can be completely attached to avoid generating air bubbles. Preferably, the depth of the notch 121 ranges from 15 um to 25 um, and the thickness of the light shielding layer 200 correspondingly ranges from 15 um to 25 um. For example, the depth of the notch 121 is 18 um, and the thickness of the light shielding layer 200 is 18 um; the depth of the notch 121 is 22 um, and the thickness of the light shielding layer 200 is 22 um; however, the present invention is not limited in this regard.

In the present application, the thickness of the light shielding layer 200 is less than the thickness of the optical adhesive layer 300 (the thickness of the optical adhesive layer 300 is a vertical distance between one side of the optical adhesive layer 300 close to the substrate 100 and one side of the optical adhesive layer 300 away from the substrate 100). In conventional techniques, in order to overcome the ink level difference problem, the thickness of the optical adhesive layer 300 is 3 to 4 times the thickness of the ink layer. By contrast, since the present application can eliminate the ink level difference caused by applying the light shielding layer 200 in conventional techniques, the thickness of the optical adhesive layer 300 can be reduced. Preferably, the thickness of the optical adhesive layer 300 in the present application is 1 to 3 times that of the light shielding layer 200. When the thickness of the light shielding layer 200 ranges from 15 um to 25 um, the thickness of the optical adhesive layer 300 correspondingly ranges from 15 um to 75 um. For example, the thickness of the light shielding layer is 16 um, and the thickness of the optical adhesive layer 300 is 40 um; the thickness of the light shielding layer is 24 um, and the thickness of the optical adhesive layer 300 is 50 um; however, the present application is not limited in this regard.

In the present application, a width of the notch 121 (the width of the notch 121 is the vertical distance between two lateral sides of the notch 121) is less than a width of the substrate 100 (the width of the substrate 100 is a vertical distance between two lateral sides of the substrate 100). In addition, the notch 121 completely covers the non-visible region 120, and the light shielding layer 200 completely fills the notch 121. In other words, the light shielding layer 200 covers the entire non-visible region 120. Those skilled in the art can understand that, in the non-visible region 120, there are usually metal traces and other devices, the metal traces and other devices are usually not evenly distributed, and the metal traces and other devices have different visual colors. By covering the entire non-visible region 120 with the light shielding layer 200, the present application can enhance the visual uniformity and improve the display effects of a display device.

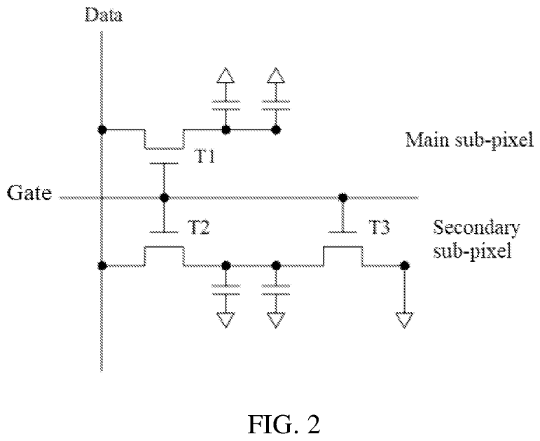

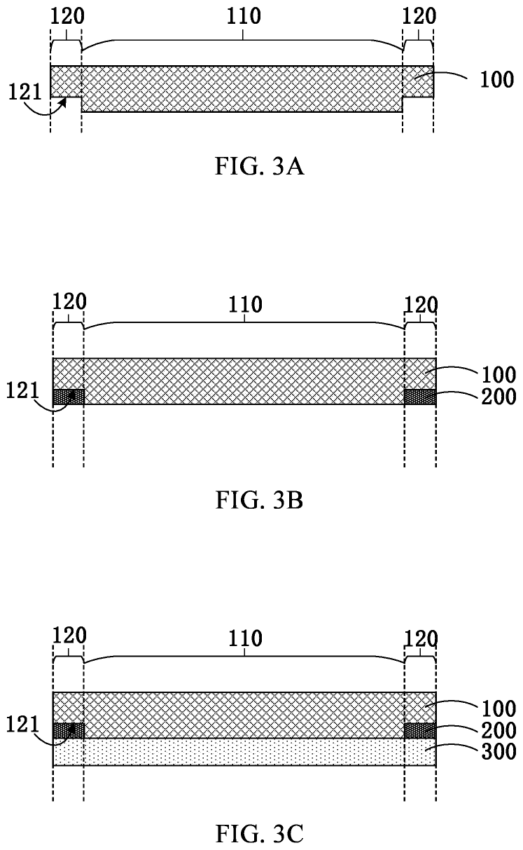

Please refer to FIGS. 2 and 3D. FIG. 2 is a process flow diagram illustrating a manufacturing method of a display cover 10. FIGS. 3A to 3D are schematic structural views illustrating each part of the display cover 10. The manufacturing method of the display cover 10 comprises following steps:

Step S1: as shown in FIG. 3A, providing a substrate 100, wherein at least one notch 121 is formed in one side of the substrate 100;

Step S2: as shown in FIG. 3B, filling a light shielding material in the notch 121 to form a light shielding layer 200; and

Step S3: as shown in FIG. 3C, forming an optical adhesive layer 300 by attaching an optical adhesive layer 300 to one side of the substrate 100 where the light shielding layer 200 is formed.

Referring to FIG. 3D, in some embodiments, the manufacturing method of the display cover 10 further comprises step S4: hardening an entire surface of the substrate 100 on one side facing away from the notch 121 to form a hardening layer 130. The hardening process is a conventional method in this field, so a detailed description thereof is omitted herein for brevity.

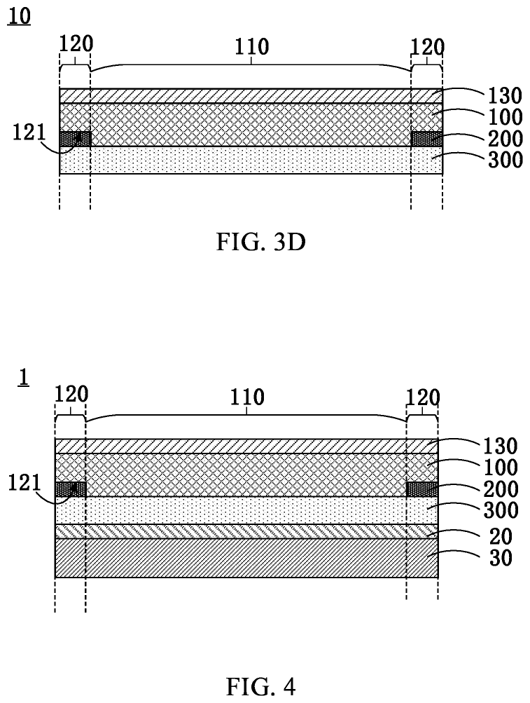

Specifically, please refer to FIG. 4, which is a schematic structural view of a display device 1 according to one embodiment of the application. The display device 1 of the present application comprises the above-mentioned display cover 10, a polarizer 20, and a display panel 30. The polarizer is a common structure in this field, so a detailed description thereof is omitted herein for brevity.

In practice, the display device 1 of the present application does not limit the type of the display panel 30. The display panel 30 can be a liquid crystal display panel, an organic electroluminescent display panel, a cathode-ray tube display panel, or a plasma display panel, an e-paper, or an electroluminescent display panel. In addition, the above-mentioned display device 1 of the present application can be any product or component with a display function, such as a mobile phone, a tablet computer, a television, a monitor, a notebook computer, a digital photo frame, or a navigator.

The present application provides a display cover 10, a manufacturing method thereof, and a display device 1. The display cover 10 comprises: a substrate 100, wherein the substrate 100 comprises a visible region 110 and a non-visible region 120, and the non-visible region 120 is provided with at least one notch 121; a light shielding layer 200, wherein the light shielding layer 200 is disposed in the notch 121 of the non-visible region 120; an optical adhesive layer 300 covering the light shielding layer 200 and the visible region 110 of the substrate 100. By arranging the light shielding layer 200 in the notch 121, the present application can eliminate the ink level difference caused by coating the light shielding layer 200 in the conventional techniques, so that the optical adhesive layer 300 is completely attached to the substrate 100, and thereby the present application can avoid generating air bubbles and improve production yields of the display cover 10, and in addition to that, since there is no ink level difference, the thickness of the optical adhesive layer 300 can be reduced, a thickness of the display device 1 can also be reduce, and the product can be more aesthetic.

In addition, the entire surface of the substrate 100 away from the notch 121 is hardened to form the hardening layer 130. The hardening layer 130 can ensure that the display cover 10 has good flexibility and bendability, and at the same time has good wear resistance and hardness, thereby improving the product quality.

In the above-mentioned embodiments, the description of each embodiment has its own emphasis. For those that are not described in detail in one embodiment, please refer to related descriptions in other embodiments.

The display cover 10 and the manufacturing method of the display cover 10 according to the present application are described in detail as above. In the above description, specific examples are used to explain the principle and embodiments of the present application. The description of the above embodiments is only used to ease understanding of the technical solutions and main ideas of the present application. Those of ordinary skill in the art should be able to modify the technical solutions described in the foregoing embodiments, or equivalently replace some of the technical features. Such modifications or replacements should be deemed to be within the protection scope of the present application.

1. A display cover, comprising:
a substrate comprising a visible region and a non-visible region, wherein the non-visible region is provided with at least one notch;
a light shielding layer disposed in the notch of the non-visible region; and
an optical adhesive layer covering the light shielding layer and the visible region of the substrate;
wherein a thickness of the light shielding layer is equal to a depth of the notch, and the thickness of the light shielding layer is less than a thickness of the optical adhesive layer.

2. The display cover according to claim 1, wherein the substrate further comprises a hardening layer disposed at one side of the substrate away from the light shielding layer and covering the substrate.

3. The display cover according to claim 1, wherein a material of the light shielding layer is light-shielding ink.

4. The display cover according to claim 1, wherein a refractive index of the substrate is less than a refractive index of the optical adhesive layer.

5. The display cover according to claim 1, wherein a material of the light shielding layer is light-shielding ink.

6. The display cover according to claim 5, wherein the light shielding ink is black light-shielding ink.

7. The display cover according to claim 1, wherein a longitudinal cross section of the notch comprises a shape of one of a triangle, a semicircle, a rectangle, a trapezoid, or other regular shapes.

8. A display cover, comprising:
a substrate comprising a visible region and a non-visible region, wherein the non-visible region is provided with at least one notch;
a light shielding layer disposed in the notch of the non-visible region; and
an optical adhesive layer covering the light shielding layer and the visible region of the substrate.

9. The display cover according to claim 8, wherein the substrate further comprises a hardening layer disposed at one side of the substrate away from the light shielding layer and covering the substrate.

10. The display cover according to claim 8, wherein a thickness of the light shielding layer is equal to a depth of the notch.

11. The display cover according to claim 8, wherein a thickness of the light shielding layer is less than a thickness of the optical adhesive layer.

12. The display cover according to claim 8, wherein a refractive index of the substrate is less than a refractive index of the optical adhesive layer.

13. The display cover according to claim 8, wherein a material of the light shielding layer is light-shielding ink.

14. The display cover according to claim 13, wherein the light shielding ink is black light-shielding ink.

15. The display cover according to claim 8, wherein a longitudinal section of the notch has a shape of one of a triangle, a semicircle, a rectangle, a trapezoid, or other regular shapes.

16. The display cover according to claim 8, wherein a material of the optical adhesive layer is at least one of an acrylic adhesive, organic silica gel, rubber, epoxy resin, and a semi-cured liquid optical adhesive.

17. A manufacturing method of the display cover of claim 1, wherein comprises following steps:
providing a substrate, wherein at least one notch is formed in one side of the substrate;
filling a light shielding material in the notch to form a light shielding layer; and
forming an optical adhesive layer by attaching an optical adhesive layer to one side of the substrate where the light shielding layer is formed.

18. The manufacturing method of the display cover according to claim 17, further comprising following steps: hardening an entire surface of the substrate on one side facing away from the at least one notch to form a hardening layer.

19. A display device, comprising the display cover and the display panel of claim 1, wherein the display cover is arranged on a light-emitting side of the display panel.

20. The display device according to claim 19, wherein the display device further comprises a polarizer arranged between the display panel and the display cover.
